(19) United States
(12) Patent Application Publication
(10) Pub. No.: US 2025/0175048 A1
(43) Pub. Date: May 29, 2025

(54) AXIAL GAP MOTOR

(71) Applicant: SHINANO KENSHI CO., LTD., Ueda-shi (JP)

(72) Inventors: Koichi ICHIKI, Nagano (JP); Atsushi KAWAKAMI, Nagano (JP)

(73) Assignee: SHINANO KENSHI CO., LTD., Ueda-shi (JP)

(21) Appl. No.: 18/792,818

(22) Filed: Aug. 2, 2024

(30) Foreign Application Priority Data
Nov. 28, 2023 (JP) 2023-200932

(51) Int. Cl. H02K 3/26; H02K 1/2793; H02K 11/21

(52) U.S. Cl. CPC H02K 3/26; H02K 1/2793; H02K 11/21; H02K 2211/03

(57) ABSTRACT

An axial gap motor includes a yoke rotatably supported, a magnetic pole portion fixed to the yoke and magnetized to have different polarities alternately in a circumferential direction around a rotation axis of the yoke, a plurality of first coils arranged in the circumferential direction and facing the magnetic pole portion in a direction of the rotation axis, a plurality of second coils arranged in the circumferential direction and facing the magnetic pole portion in the direction of the rotation axis, and a position sensor surrounded by any of the plurality of first coils and detecting a rotational position of the yoke.

### CROSS-REFERENCE TO RELATED APPLICATION

This application is based upon and claims the benefit of priority of the prior Japanese Patent Application No. 2023-200932, filed on Nov. 28, 2023, the entire contents of which are incorporated herein by reference.

### BACKGROUND

### (i) Technical Field

The present disclosure relates to an axial gap motor.

### (ii) Related Art

An axial gap motor including a plurality of coils and a position sensor that detects a rotational position of a yoke is known (See, for example, Japanese Unexamined Utility Model (Registration) Application Publication No. 59-013082).

In order to avoid interference with the position sensor, a plurality of coils are installed at positions away from the position sensor. Therefore, the installation area of the coils might be reduced, and it might be difficult to provide many coils at appropriate positions, which might deteriorate the characteristics of the motor.

### SUMMARY

According to an aspect of the present disclosure, there is provided an axial gap motor including: a yoke rotatably supported; a magnetic pole portion fixed to the yoke and magnetized to have different polarities alternately in a circumferential direction around a rotation axis of the yoke; a plurality of first coils arranged in the circumferential direction and facing the magnetic pole portion in a direction of the rotation axis; a plurality of second coils arranged in the circumferential direction and facing the magnetic pole portion in the direction of the rotation axis; and a position sensor surrounded by any of the plurality of first coils and detecting a rotational position of the yoke.

### BRIEF DESCRIPTION OF THE DRAWINGS

FIG. 1 is a front view of an axial gap motor;

FIG. 2 is a sectional view taken along line A-A in FIG. 1;

FIG. 3 is a front view of a coil unit;

FIG. 4 is a rear view of the coil unit;

FIG. 5 is a front view of a printed circuit board in a state where a reinforcing plate is removed from the coil unit;

FIG. 6 is a front view of the printed circuit board in a state where the reinforcing plate and frame bodies removed from the coil unit; and

FIG. 7 is a sectional view taken along line B-B of FIG. 3.

### DETAILED DESCRIPTION

### Schematic Configuration of Axial Gap Motor

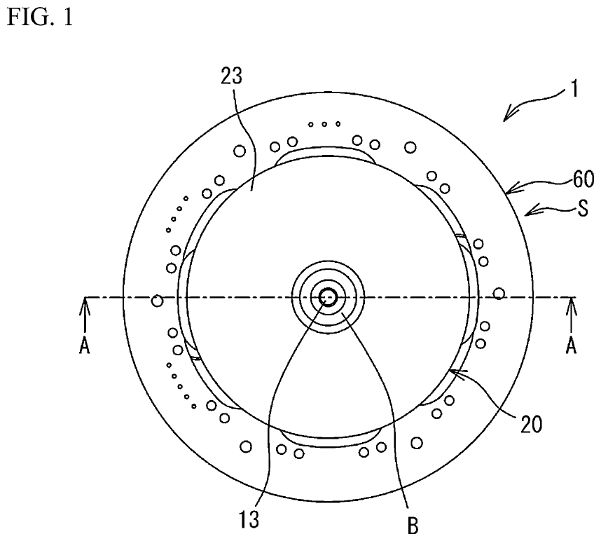

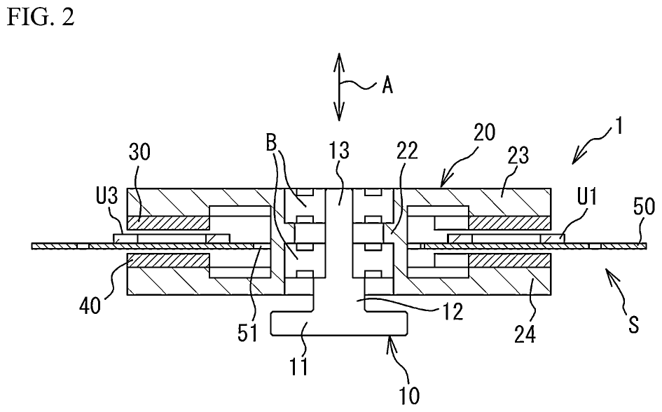

FIG. 1 is a front view of an axial gap motor 1. FIG. 2 is a cross-sectional view taken along line A-A of FIG. 1. FIG. 2 schematically illustrates the axial gap motor 1, and a part of the configuration is omitted. The axial gap motor 1 includes a support shaft 10, a yoke 20, magnetic pole portions 30 and 40, and a coil unit S. The support shaft 10 rotatably supports the yoke 20. The support shaft 10 includes a flange portion 11, a step portion 12, and a thin shaft portion 13. The step portion 12 has a smaller diameter than the flange portion 11. The thin shaft portion 13 has a smaller diameter than the step portion 12. Two bearings B are held by the thin shaft portion 13. The yoke 20 includes a cylindrical portion 22 and flange portions 23 and 24. The flange portions 23 and 24 are each in a flange shape. The flange portions 23 and 24 are separated from each other in an axial direction A. The coil unit S includes a printed circuit board 50 and a reinforcing plate 60. In FIG. 2, the reinforcing plate 60 is omitted. The coil unit S is disposed between the flange portions 23 and 24.

The magnetic pole portion 30 is provided on a surface of the flange portion 23 facing the coil unit S. The magnetic pole portion 40 is provided on a surface of the flange portion 24 facing the coil unit S. Each of the magnetic pole portions 30 and 40 is an annular permanent magnet. Each of the surfaces of the magnetic pole portions 30 and 40 facing the coil unit S is magnetized to have polarities alternately different from each other in the circumferential direction. In the present embodiment, each of the magnetic pole portions 30 and 40 has eight poles in the circumferential direction. Each of the magnetic pole portions 30 and 40 may be a plurality of permanent magnets arranged in the circumferential direction. In this case, the surfaces of the plurality of permanent magnets facing the coil unit S are magnetized to have polarities alternately different in the circumferential direction. The magnetic pole portions 30 and 40 correspond to first and second magnetic pole portions.

The printed circuit board 50 is provided with a plurality of coils, which will be described in detail later. These coils facing the magnetic pole portions 30 and 40 via gaps in the axial direction A. By controlling the energization state of these coils, the yoke 20 rotates with respect to the support shaft 10 in accordance with the magnetic force generated between the coils and the magnetic pole portion 30 and between the coils and the magnetic pole portion 40. The coil unit S is held at its outer peripheral end by a holder (not illustrated), and is not rotatable relative to the yoke 20.

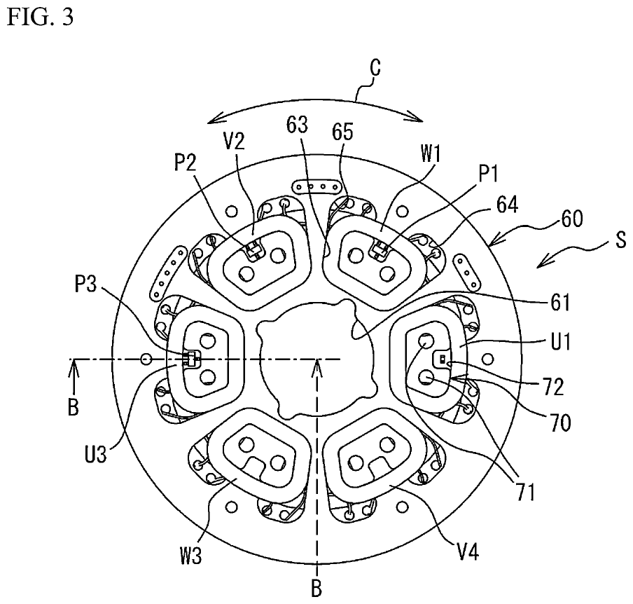

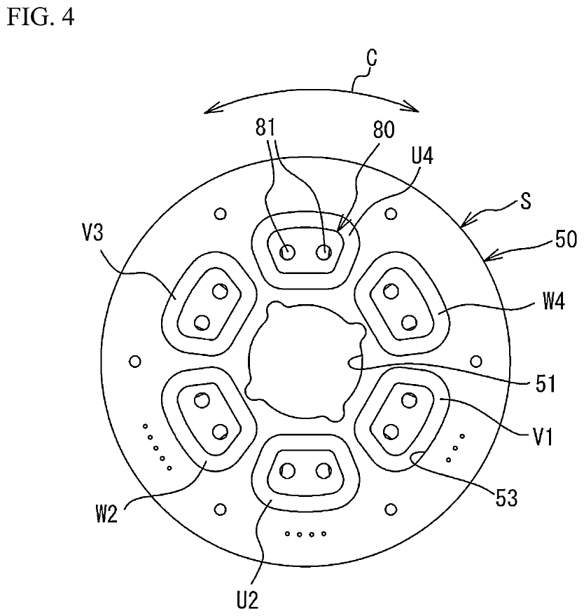

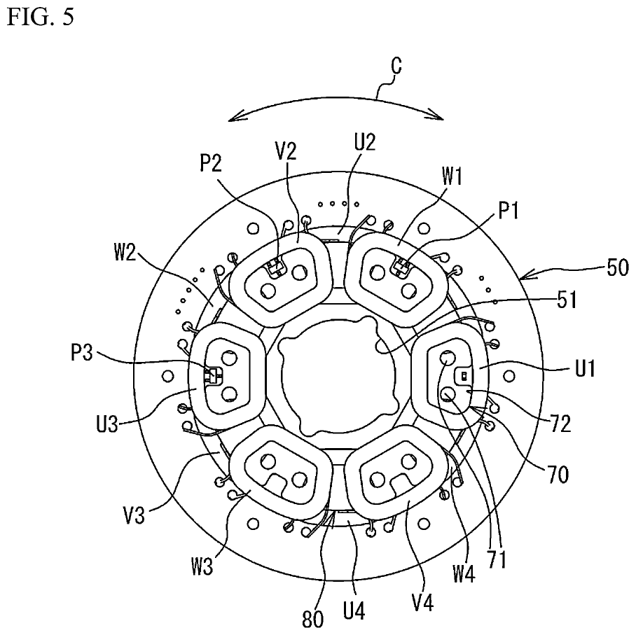

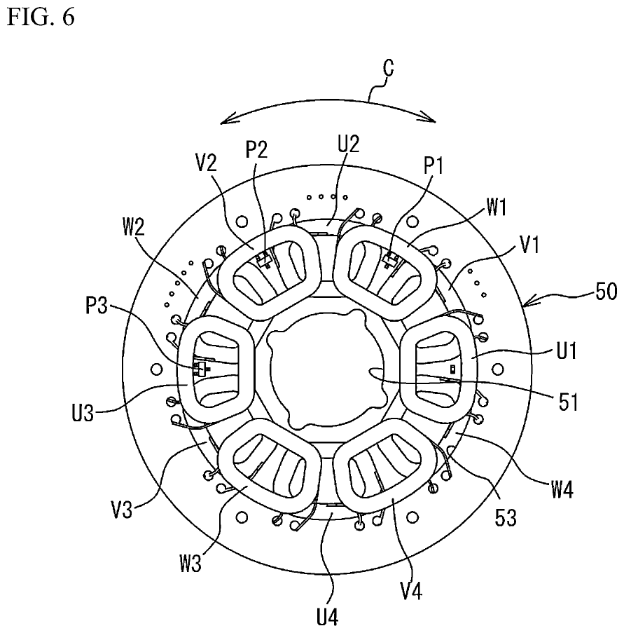

FIG. 3 is a front view of the coil unit S. FIG. 4 is a rear view of the coil unit S. FIG. 5 is a front view of the printed circuit board 50 in a state where the reinforcing plate 60 is removed from the coil unit S. FIG. 6 is a front view of the printed circuit board 50 in a state where the reinforcing plate 60 and the frame bodies 70 and 80 are removed from the coil unit S. Each of the printed circuit board 50 and the reinforcing plate 60 has a circular shape. Openings 51 and 61 for allowing the support shaft 10 to escape are formed in the center of the printed circuit board 50 and the reinforcing plate 60, respectively.

As illustrated in FIG. 6, coils U1 to U4 of a U phase, coils V1 to V4 of a V phase, and coils W1 to W4 of a W phase are assembled to the printed circuit board 50. The coils U1 to U4 are configured by distributed winding. The same applies to the coils V1 to V4 and W1 to W4. The coils U1 to U4, V1 to V4, and W1 to W4 are electrically connected to the printed circuit board 50. The coils U1, V1, W1, U2, V2, W2, U3, V3, W3, U4, V4, and W4 are arranged in a circumferential direction C (counterclockwise in FIG. 6). The coils U1 to U4 are set at intervals of 90 angular degrees in the circumferential direction C. The coils V1 to V4 are set at intervals of 90 angular degrees in the circumferential direction C. The coils W1 to W4 are set at intervals of 90 angular degrees in the circumferential direction C.

As illustrated in FIG. 6, the coils U1, W1, V2, U3, W3, and V4 are disposed on the same surface of the printed circuit board 50 at intervals of 60 angular degrees in the circumferential direction C, and correspond to a plurality of first coils. The coils V1, U2, W2, V3, U4, and W4 are embedded in the printed circuit board 50 at intervals of 60 angular degrees in the circumferential direction C, and correspond to a plurality of second coils. The number of coils installed on the printed circuit board 50 and the number of coils embedded in the printed circuit board 50 are the same, i.e., six.

As illustrated in FIG. 6, the coil U1 is partially overlapped with the coils W4 and V1 in the axial direction A and is separated therefrom in the axial direction A. The coil W1 is partially overlapped with the coils V1 and U2 in the axial direction A and is separated therefrom in the axial direction A. The coil V2 is partially overlapped with the coils U2 and W2 in the axial direction A and is separated therefrom in the axial direction A. The coil U3 is partially overlapped with the coils W2 and V3 in the axial direction A and is separated therefrom in the axial direction A. The coil W3 is partially overlapped with the coils V3 and U4 in the axial direction A and is separated therefrom in the axial direction A. The coil V4 is partially overlapped with the coils U4 and W4 in the axial direction A and is separated therefrom in the axial direction A. The coil V1 is partially overlapped with the coils U1 and W1 in the axial direction A and is separated therefrom in the axial direction A. The coil U2 is partially overlapped with the coils W1 and V2 in the axial direction A and is separated therefrom in the axial direction A. The coil W2 is partially overlapped with the coils V2 and U3 in the axial direction A and is separated therefrom in the axial direction A. The coil V3 is partially overlapped with the coils U3 and W3 in the axial direction A and is separated therefrom in the axial direction A. The coil U4 is partially overlapped with the coils W3 and V4 in the axial direction A and is separated therefrom in the axial direction A. The coil W4 is partially overlapped with the coils V4 and U1 in the axial direction A and is separated therefrom in the axial direction A. Thus, the axial gap motor 1 is prevented from being increased in size in the axial direction A.

As illustrated in FIG. 3, the coils U1, W1, V2, U3, W3, and V4 are fitted into holes 63 of the reinforcing plate 60, respectively. Thus, the outer peripheries of the coils U1, W1, V2, U3, W3, and V4 are reinforced. The hole 63 is continuously formed with cutout portions 64 and 65 for allowing lead-out wires from the coils to escape. The reinforcing plate 60 is an example of a reinforcing member. Instead of the reinforcing plate 60, the outer peripheries of the coils U1, W1, V2, U3, W3, and V4 on the printed circuit board 50 may be sealed with resins.

As illustrated in FIGS. 4 to 6, the coils V1, U2, W2, V3, U4, and W4 are embedded so as to be fitted into holes 53 of the printed circuit board 50, respectively. Therefore, the strength of these coils is secured.

As illustrated in FIGS. 3 and 5, the coils U1, W1, V2, U3, W3, and V4 are wound around frame bodies 70, respectively. As illustrated in FIG. 4, the coils V1, U2, W2, V3, U4, and W4 is wound around frame bodies 80, respectively. This ensures the strength of these coils. Two positioning holes 71 are formed in the frame body 70. The positioning hole 71 is used for positioning when the frame body 70 around which the coil is wound is installed on the printed circuit board 50. Similarly, two positioning holes 81 are formed in the frame body 80. The positioning hole 81 is used for positioning when the frame body 80 around which the coil is wound is fitted into the hole 53 of the printed circuit board 50.

As illustrated in FIG. 6, the coils U1 to U4, V1 to V4, and W1 to W4 have the same shape. Therefore, the work of winding the coil around the frame body 70 or 80 is the same, and the work is easy. In addition, the coils are easy to handle during assembly. Specifically, a jig with a rod-shaped positioning component (not illustrated) is inserted into the positioning hole 71 or the positioning hole 81, and the frame body 70 or the frame body 80 around which the coil is wound is positioned at a predetermined position of the printed circuit board 50 and fixed to the printed circuit board 50 by adhesion or the like.

As illustrated in FIGS. 3 and 5, a cutout portion 72 is formed in the frame body 70. Position sensors P1, P2, and P3 are surrounded by the coils W1, V2, and U3, respectively. In detail, the position sensor P1 is located in the cutout portion 72 of the frame body 70 around which the coil W1 is wound. The position sensor P2 is located in the cutout portion 72 of the frame 70 around which the coil V2 is wound. The position sensor P3 is located in the cutout portion 72 of the frame 70 around which the coil U3 is wound. In this way, the position sensors P1 to P3 are prevented from interfering with the coils W1, V2, and U3, respectively. As a result, the installation areas of the coils U1 to U4, V1 to V4, and W1 to W4 are secured. Note that the position sensors P1 to P3 are Hall elements.

As illustrated in FIG. 6, the position sensor P1 is disposed between the coils V1 and U2 adjacent to each other in the circumferential direction C. The position sensor P2 is disposed between the coils U2 and W2 adjacent to each other in the circumferential direction C. The position sensor P3 is disposed between the coils W2 and V3 adjacent to each other in the circumferential direction C. In this way, the dead space on the printed circuit board 50 is effectively utilized.

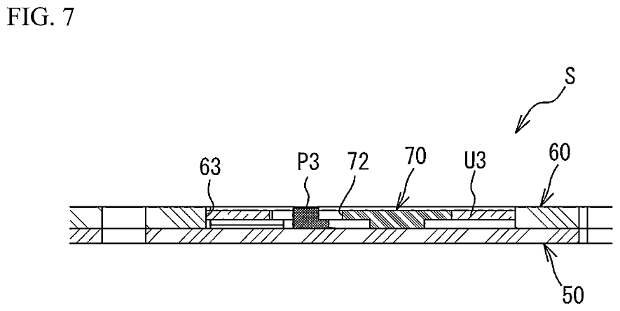

FIG. 7 is a cross-sectional view taken along line B-B of FIG. 3. The position sensor P3 surrounded by the coil U3 does not protrude from the end surface of the reinforcing plate 60. This ensures the coil unit S to be thin in the axial direction A. Further, for example, it is possible to avoid the operator from touching the position sensor P3 when handling the coil unit S. The same applies to the position sensors P1 and P2.

As described above, the coils U1 to U4, V1 to V4, and W1 to W4 are three-phase coils. The total number of these coils is an even number of 12. The number of poles of each of the magnetic pole portions 30 and 40 is eight. Thus, the total number of coils is 1.5 times the number of poles.

As another example, the total number of coils may be six, which is an even number, and the number of poles of the magnetic pole portion may be four. In this case, the number of coils of each of the U phase, the V phase, and the W phase is two. For example, three coils may be provided on a printed circuit board, and the remaining three coils may be embedded in the printed circuit board. Again, the total number of coils is 1.5 times the number of poles.

As still another example, the total number of coils may be 18, which is an even number, and the number of poles of the magnetic pole portion may be 6. In this case, the number of coils of each of the U phase, the V phase, and the W phase is six. For example, nine coils may be provided on a printed circuit board, and the remaining nine coils may be embedded in the printed circuit board. In this case, the total number of coils is three times the number of poles.

When the coils are wound in a distributed manner, the position sensor is surrounded by one of the coils from which two other coils are spaced apart in the axial direction and the two other coils are adjacent to each other in the circumferential direction C, the position sensor is disposed between the two other coils, as in the above-described example, the coils are the three-phase coils, and the total number of coils may be preferably an even number and 1.5 or 3 times the number of poles. This allows the coils and the position sensor to be arranged at theoretical positions without interference. Further, 1.5 times the number of poles is preferable. This is because, when the number of poles is increased to three times the number of poles, the number of coils required is increased, and the structure is complicated accordingly, which makes the manufacturing difficult.

The yoke 20 of the axial gap motor 1 of the present embodiment is provided with the magnetic pole portions 30 and 40, but only one of the magnetic pole portions 30 and 40 may be provided.

While the exemplary embodiments of the present disclosure have been illustrated in detail, the present disclosure is not limited to the above-mentioned embodiments, and other embodiments, variations and variations may be made without departing from the scope of the present disclosure.

What is claimed is:

1. An axial gap motor comprising:
a yoke rotatably supported;
a magnetic pole portion fixed to the yoke and magnetized to have different polarities alternately in a circumferential direction around a rotation axis of the yoke;
a plurality of first coils arranged in the circumferential direction and facing the magnetic pole portion in a direction of the rotation axis;
a plurality of second coils arranged in the circumferential direction and facing the magnetic pole portion in the direction of the rotation axis; and
a position sensor surrounded by any of the plurality of first coils and detecting a rotational position of the yoke.

2. The axial gap motor according to claim 1,
wherein
any one of the plurality of first coils partially overlaps two of the second coils, adjacent to each other in the circumferential direction, in the direction of the rotation axis, and
any one of the plurality of second coils partially overlaps two of the first coils, adjacent to each other in the circumferential direction, in the direction of the rotation axis.

3. The axial gap motor according to claim 2, further comprising a printed circuit board electrically connected to the plurality of first coils, the plurality of second coils, and the position sensor,
wherein
the plurality of first coils and the position sensor are disposed on the printed circuit board, and
the plurality of second coils are embedded in the printed circuit board.

4. The axial gap motor according to claim 3, wherein the position sensor is disposed between two of the second coils adjacent to each other in the circumferential direction.

5. The axial gap motor according to claim 1,
wherein
each of the plurality of first coils and the plurality of second coils is wound by distributed winding,
the plurality of first coils and the plurality of second coils are three-phase coils, and
a total number of the plurality of first coils and the plurality of second coils is an even number, and is 1.5 times or 3 times a number of poles of the magnetic pole portion.

6. The axial gap motor according to claim 1, further comprising a first coil frame around which any of the plurality of first coils is wound,
wherein the first coil frame includes a cutout portion for allowing the position sensor to receive.

7. The axial gap motor according to claim 3, further comprising a second coil frame around which any of the plurality of second coils is wound,
wherein the second coil wound around the second coil frame is embedded in the printed circuit board together with the second coil frame.

8. The axial gap motor according to claim 1,
wherein
the magnetic pole portion includes first and second magnetic pole portions spaced apart from each other in the direction of the rotation axis, and
the plurality of first coils and the plurality of second coils are disposed between the first and second magnetic pole portions.
